(19) United States
(12) Patent Application Publication
(10) Pub. No.: US 2026/0093954 A1
(43) Pub. Date: Apr. 2, 2026

(54) SYSTEMS AND METHODS FOR A TIME SERIES FORECASTING TRANSFORMER NETWORK

(71) Applicant: Salesforce, Inc., San Francisco, CA (US)

(72) Inventors: Xu Liu, Singapore (SG); Juncheng Liu, Singapore (SG); Ibrahim Taha Aksu, Singapore (SG); Chenghao Liu, Singapore (SG); Silvio Savarese, Palo Alto, CA (US); Caiming Xiong, Menlo Park, CA (US); Doyen Sahoo, Singapore (SG)

(21) Appl. No.: 19/029,457

(22) Filed: Jan. 17, 2025

Related U.S. Application Data
(60) Provisional application No. 63/701,811, filed on Oct. 1, 2024.

(51) Int. Cl. G06N 3/045; G06N 3/08

(52) U.S. Cl. CPC G06N 3/045; G06N 3/08

(57) ABSTRACT

Embodiments described herein provide a Transformer-based neural network architecture that comprises mixture-of-experts time series foundation models to predict different types of time series data. Specifically, given an input multi-variate time series data, a single projection layer may be used to generate patch embeddings for the different time series patterns. The patch embeddings are then passed to a Transformer self-attention layer to compute attention weights, based on which a gating function assigns the patch embeddings into different time series clusters to be further fed to different expert such as feed-forward layers. The feed-forward layers in turn predict a distribution. The output tokens of forecasted time series data are then decoded via the output projection layers from the predicted distribution.

### CROSS REFERENCE

The instant application is a nonprovisional of and claims priority under 35 U.S.C. 119 to U.S. provisional application No. 63/701,811, filed Oct. 1, 2024, which is hereby expressly incorporated by reference herein in its entirety.

### TECHNICAL FIELD

The embodiments relate generally to neural networks and machine learning systems, and more specifically to a time series forecasting Transformer neural network.

### BACKGROUND

Time series data is widely used in different applications, such as weather forecasting, financial analytics with stock market dynamics, and/or the like. Existing neural network models may be trained to predict time-series data, e.g., predicting the weather for a future time period given the past weather data. However, for different types of time-series data, time series data distribution can be imbalanced across different frequencies (e.g., different frequency per day, per hour, per month, etc.), leading to insufficient training of parameters for less frequent data. Also, frequency-level specialization is coarse-grained. For example, time series with similar patterns but different frequencies can produce dissimilar embeddings, while those within the same frequency may exhibit various patterns. Such characteristics may be difficult for a single linear layer to capture.

Therefore, there is a need to improve time series data forecasting models for forecasting different types of time-series data.

### BRIEF DESCRIPTION OF THE DRAWINGS

FIG. 1 provides a simplified diagram illustrating different examples of time series data of different frequencies, according to embodiments described herein.

FIG. 2A provides a simplified diagram illustrating an example architecture of the Transformer based time series model, according to embodiments described herein.

FIG. 2B provides a simplified diagram illustrating an example architecture of the Transformer layer of the Transformer model described in FIG. 2A, according to embodiments described herein

FIG. 3 is a simplified diagram illustrating a computing device implementing the time series forecasting framework described in FIGS. 1-2, according to one embodiment described herein.

FIG. 4 is a simplified diagram illustrating the neural network structure implementing the time series forecasting module described in FIG. 3, according to some embodiments.

FIG. 5 is a simplified block diagram of a networked system suitable for implementing the time series forecasting framework described in FIGS. 1-4 and other embodiments described herein.

FIG. 6 is a simplified logic flow diagram illustrating aspects of a method of forecasting time series data for a future time period based on the Transformer based time series model illustrated in FIGS. 1-5, according to embodiments described herein.

FIG. 7 is a simplified logic flow diagram illustrating aspects of a method of training the Transformer based time series model illustrated in FIGS. 1-5, according to embodiments described herein.

FIGS. 8-11 provide example data charts illustrating example performance of the Transformer based time series model illustrated in FIGS. 1-5, according to embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

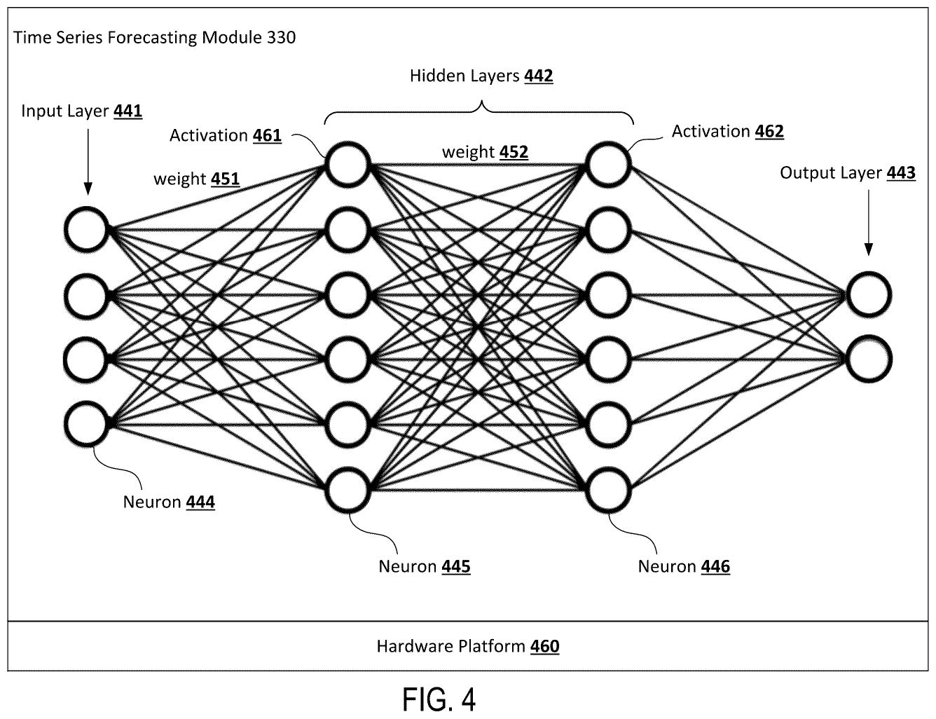

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture often comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 4.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

Time series data, due to its nature in different practical applications (such as weather forecasting, financial market dynamics and/or the like) may have different frequencies, e.g., per day, per hour, per month, etc. Given the heterogeneity of time series, frequency-level specialization remains challenging to be recognized by a single prediction model. Specifically, time series data naturally may exhibit imbalances across frequencies; for instance, the number of monthly observations is generally much fewer than that of hourly ones. This disparity can result in insufficient training for parameters associated with underrepresented frequencies, reducing the effectiveness of cross-frequency learning. Even with techniques like data upsampling as a partial remedy, such data imbalance across frequencies is to be fundamentally addressed. In addition, frequency variations alone may not always a reliable indicator and might not effectively capture the true structure of the time series data. Time series with different frequencies can exhibit similar patterns, while those with the same frequency may display diverse and unrelated patterns. This mismatch in frequency and pattern undermines the efficacy of model specialization, resulting in subpar performance in time series data forecasting. Inaccurate prediction results (such as inaccurate weather forecast) often lead to damages and/or even danger to operations in different technical fields.

In view of the need for an efficient and accurate time series forecasting system that accommodates different types of time series data, embodiments described herein provide a Transformer-based neural network architecture that comprises mixture-of-experts time series foundation models to predict different types of time series data. Specifically, given an input multi-variate time series data, a single projection layer may be used to generate patch embeddings for the different time series patterns. The patch embeddings are then passed to a Transformer self-attention layer to compute attention weights, based on which a gating function assigns the patch embeddings into different time series clusters to be further fed to different expert such as feed-forward layers. The feed-forward layers in turn predict a distribution. The output tokens of forecasted time series data are then decoded via the output projection layers from the predicted distribution.

In this way, the single Transformer based time series model may be trained on a vast collection of time series datasets of different types of times series data to perform diverse downstream forecasting tasks. Time series data of different frequencies (e.g., hourly, daily, weekly, monthly, yearly, etc.) and/or with an arbitrary number of variates for multivariate time series, and having varying distributional properties inherent in large-scale data may be combined into a single training dataset to train the single Transformer based time series model. The trained Transformer based time series model may thus be able to perform time series data forecasting for these different types of time series data without repeated retraining of the model.

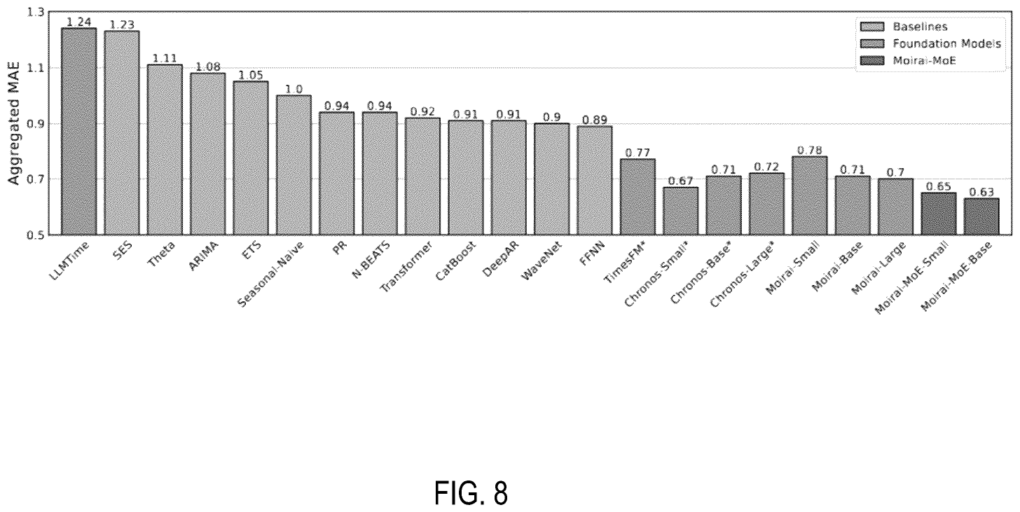

As further shown in FIGS. 8-11, example data experiments on 39 datasets show that the trained Transformer based time series model achieves up to 17% performance improvements over existing time-series prediction models at the same level of model size, and outperforms other existing time series foundation models with up to 65× fewer activated parameters. In this way, computational and hardware efficiency of neural network technology in time-series data forecasting is largely improved.

In addition, with improved time series forecasting accuracy in a wide variety of applications, such as weather forecasting, network traffic forecasting, and/or the like, neural network technology has been improved.

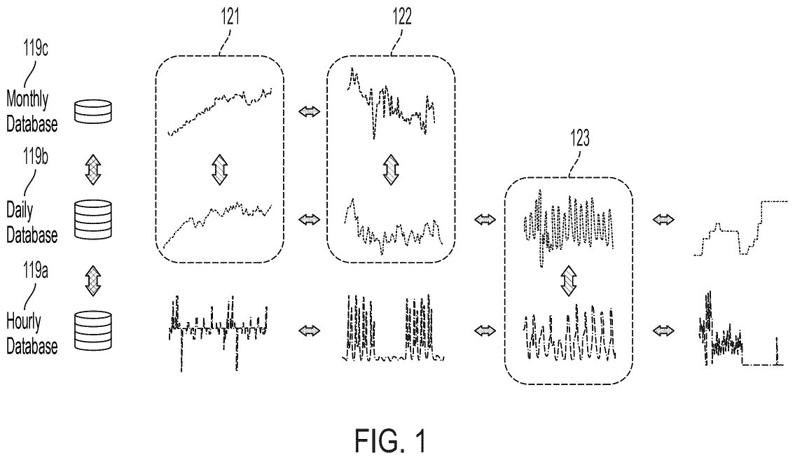

FIG. 1 provides a simplified diagram illustrating different examples of time series data of different frequencies, according to embodiments described herein. As shown in FIG. 1, time series data may have different frequencies, e.g., monthly time series 119c (such as but not limited to environmental data including average monthly temperature, monthly rainfall, and/or the like), daily time series 119b (such as but not limited to health and mobility data including new cases of diseases, step counts from fitness trackers, public transport ridership, and/or the like), hourly time series 119a (such as transportation data including traffic volume on roads or highways, flight arriving/departing, and/or the like).

As shown at different rows corresponding to 119a-119c, within each frequency, time series data may be highly varied. Or time series with similar patterns (shown at arrows 121, 122, 123) may originate from different frequencies. Thus, grouping time series by frequency may pose thus challenges in frequency-level model specialization: the imbalance in data sizes across frequencies, the heterogeneity of patterns within the same frequencies, and the homogeneity of patterns across frequencies.

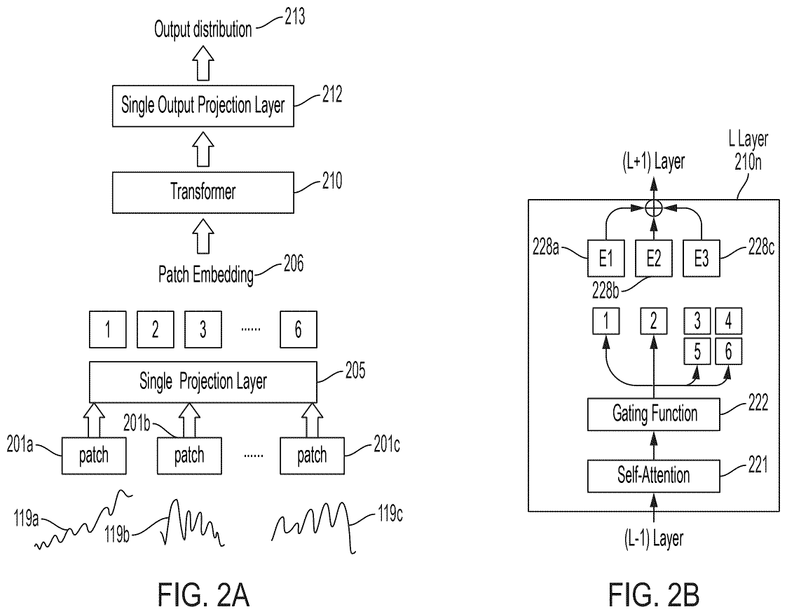

FIG. 2A provides a simplified diagram illustrating an example architecture of the Transformer based time series model, according to embodiments described herein. As shown in FIG. 2A, times series data for a given time period 119a-119c, regardless of its frequency or pattern, may be formed into an input sequence of time series data. When the time series data (e.g., any of 119a-119c) contains multiple time-varying variates, the time series data may be flattened, e.g., by concatenating the respective time series sequence of each time-varying variate into one input sequence.

In one embodiment, the input sequence is segmented into non-overlapping patches of the same size, resulting in a sequence of patches. For example, given a time series with length S (S time instances), the sequence of the time series may be segmented into non-overlapping patches 201a-201c of size P, resulting in a sequence of patches x∈ [symbol] ^{N×P}, where

$$N = [ \frac{S}{P} ]$$

is the number of patches. Each of patches 201a-c may capture local semantic information, and reduces computational overhead compared to processing long inputs as the original time series sequence of length S.

In one embodiment, the patches 201a-c may be then normalized to mitigate distribution shifts. For example, in a decoder-only (autoregressive) model, where each patch 201a-c may be used to predict its succeeding patch, applying a causal normalizer to each patch may achieve accurate normalization. However, this approach could generate N subsequences with different lengths, diminishing the parallel training that decoder-only models typically offer. To address this problem, a masking ratio r may be applied as a hyperparameter for normalization, which specifies the portion of the entire sequence used exclusively for robust normalizer calculation, without contributing to the prediction loss.

In one embodiment, after normalization, the patches 201a-201c may be fed to a single projection layer 205 to generate patch embeddings 206, e.g., time series tokens x∈ [symbol] ^{N×D}, where D is the dimension of Transformer 210. The projection layer 205 may be implemented as a residual multi-layer perceptron to enhance representation capacity.

In one embodiment, the one or more patch embeddings 206 (e.g., time series tokens) may be then passed to a decoder-only Transformer structure 210 comprising a stack of layers of Transformer blocks. For example, as shown in FIG. 2B, each Transformer layer 210n comprises a causal self-attention module 221, followed by a gating function module 222 and one or more expert modules 228a-228c, each of which specialized in processing a distinct pattern of timer series data. In some implementations, each expert module 228a-228c may be a feed forward layer.

In one embodiment, for example, at the l-th layer 210, intermediate input sequence from the (1-1)th layer may be fed to the causal self-attention module 221, represented by:

$${\tilde{x}}^{l} = CSA ( LN ( {x}^{l} ) ) + {x}^{l}$$

where \tilde{x}^{l}∈ [symbol] ^{N×D} are the hidden states of all tokens after the attention module 221 of the l-th layer and x^{l}∈ [symbol] ^{N×D} are the input hidden states of the l-th layer; CSA, and LN denote a causal self-attention module, and the layer normalization, respectively. As described above, multivariate correlations may be captured by flattening all variates of time series data 119a, 119b or 119c into an input sequence. During causal attention, each token is allowed to attend to its preceding tokens, as well as preceding tokens from other variates.

In one embodiment, output hidden states of the self attention module 221, \tilde{x}^{l} may then be fed to the gating function module 222. The gating function module 222 is followed by a set of specialized expert modules 228a-228c, each of which is specialized in handling a particular pattern of time series, represented by M expert networks {E₁, . . . , E_{M}}. The gating function G determines which subset of experts {E₁, . . . , E_{M}} 228a-228c is activated for each time series token 206, e.g., by computing G(\tilde{x}^{l})ᵢ as the i-th token-to-expert affinity score generated by the gating function. In this way, each expert 228a-228c only specializes in processing a respective distinct pattern of time series data and thus ensures computational efficiency.

For example, the gating function module 222 may be a linear projection layer. In this case, the gating function takes the softmax over the Top-K logits of a linear projection parameterized by W_{g}∈ [symbol] ^{D×M}:

$$G ( {\tilde{x}}^{l} ) = Softmax ( TopK ( {\tilde{x}}^{l} \cdot {W}_{g} ) )$$

For another example, the gating function module 222 may be a token clustering module to cluster tokens. The gating function may compute cluster centroids derived from the token representations of a pretrained model to determine which of the specialized expert modules 228a-228c should be allocated a particular time series token. This is because clusters of pretrained token embeddings may more closely reflect the real distribution of the data, leading to more effective expert specialization compared to a randomly initialized linear projection layer. Specifically, a Transformer model 210 may be pretrained using single-patch input/output projection layers 205 and 212 to mitigate the human-imposed frequency biases. The trained Transformer model 210 may perform Inference using the pretraining data. For a batch [symbol] containing T tokens, the attention outputs \tilde{x}^{l}∈ [symbol] ^{T×D} may be extracted at each layer 210n and mini-batch k-means clustering may be performed in the attention outputs to continuously learn clusters at each layer. In other words, K centroids may be randomly initialized (or select them from the attention outputs), and then each attention output is assigned to the cluster whose centroid is closest (usually using the Euclidean distance) to the attention output-after finishing a batch of time series data, the centroids of the clusters are updated by averaging the attention outputs in each cluster. This clustering process may be iteratively performed until the centroids no longer change significantly or a maximum number of iterations is reached.

In one embodiment, the number of clusters is set to match the total number of experts 228a-228c, e.g., one cluster per one specialized expert for a distinct time series pattern. For each layer 210n of the Transformer 210, each token computes the Euclidean distance to learned cluster centroids C∈ [symbol] ^{M×D}, and these distances serve as token-to-expert affinity scores for expert assignments:

$$G ( {\tilde{x}}^{l} ) = Softmax ( TopK ( Euclidean ( {\tilde{x}}^{l} \cdot C ) ) )$$

In one embodiment, gating function outputs, such as the token-to-expert affinity scores are used to assign time series tokens to the specialized expert modules 228a-228c, and the output from the expert layers 228a-228c may then be computed as:

$${\sum }_{i = 1}^{M} {G ( {\tilde{x}}^{l} )}_{i} \cdot {E}_{i} ( {\tilde{x}}^{l} )$$

where Eᵢ(\tilde{x}^{l}) is the output of the i-th expert module, and G(\tilde{x}^{l})ᵢ is the i-th token-to-expert affinity score generated by the gating function module 222. For example, the number of activated experts to K=2.

In one embodiment, with reference back to FIG. 2A, the Transformer output from the L stacked layers of Transformer layers 210n may then be passed to the output projection layer 212 to generate an output distribution 213 representing a predicted time series data at a future time period. For example, during training, the output distribution 213 may be compared with known ground-truth time series from the training data to compute a loss. During inference, the output distribution 213 may represent predicted future time series that is unknown—in this case, a predicted time series over a future time window may be generated by sampling according to the output distribution 213.

It is noted that as neither the input projection layer 205 nor the output projection layer 212 involves the specific frequency of the time series 119a-c. Instead, the pattern characteristics, regardless of frequency, of time series data 119a-c may be captured by attending the patch embeddings according to their distinct patterns by different experts 228a-228c within each Transformer layer. In that case, output projection layer 212 may generate the output distribution 213 predicting a “pattern trajectory” reflecting the future time series for input time series 119a-c, respectively, regardless of their respective frequencies.

In one embodiment, during training of Transformer 210, a time-series training sample may be segmented into a first period (context window) and a second period (predicted window). Let x_{t-1+1:t}={xₜ₋₁₊₁, . . . , xₜ} denote the context window of length l for a token at position t. To facilitate both point and probabilistic forecasting, Transformer 210 may forecast the predictive distribution 213 of the next token p(xₜ₊₁|φ) by predicting the mixture distribution parameters \hat{φ}. For example, the output distribution 213 may be a mixture distribution of Gaussian distribution and any other types of distributions with predicted mean and variance parameters. These parameters are derived from the output tokens of the Transformer 210, followed by a single output projection layer 212. Therefore, a prediction loss may be computed as the following negative log-likelihood during training:

$${ℒ}_{pred} = - log p ( {x}_{t + 1} \vert \hat{ϕ} ) , \hat{ϕ} = {f}_{θ} ( {x}_{t - l + 1 : t} ) \qquad ( 1 )$$

where f denotes the transformation from input projection layer 205, Transformer 210 and the output projection layer 212, and θ denotes the weights of Transformer 210.

In some implementations, sparse gating at gating function module 222 may result in a load balancing issue. To mitigate this effect, during training, an auxiliary loss may be introduced to encourage an even distribution of tokens across expert layers 228a-228c. Thus, the load balancing loss for a batch [symbol] containing T tokens can be computed as:

$${ℒ}_{load} = {\sum }_{l = 1}^{M} {𝒟}_{i} {𝒫}_{i} , where {𝒟}_{i} = \frac{1}{T} {\sum }_{t = 1}^{T} 𝕀 \{ Token t selects Expert i \} , \qquad ( 2 )$$

$${𝒫}_{i} = \frac{1}{T} {\sum }_{t = 1}^{T} {G ( {\tilde{x}}^{l} )}_{i}$$

where ∥ is the indicator function, [symbol] ᵢ denotes the fraction of tokens routed to expert i, and [symbol] ᵢ indicates the proportion of the gating probability allocated to expert i. The loss [symbol] _{load} is applied to each Transformer layer I. It is then aggregated by computing the mean across all layers and added to the prediction loss [symbol] _{pred} with a weight of 0.01.

### Computer and Network Environment

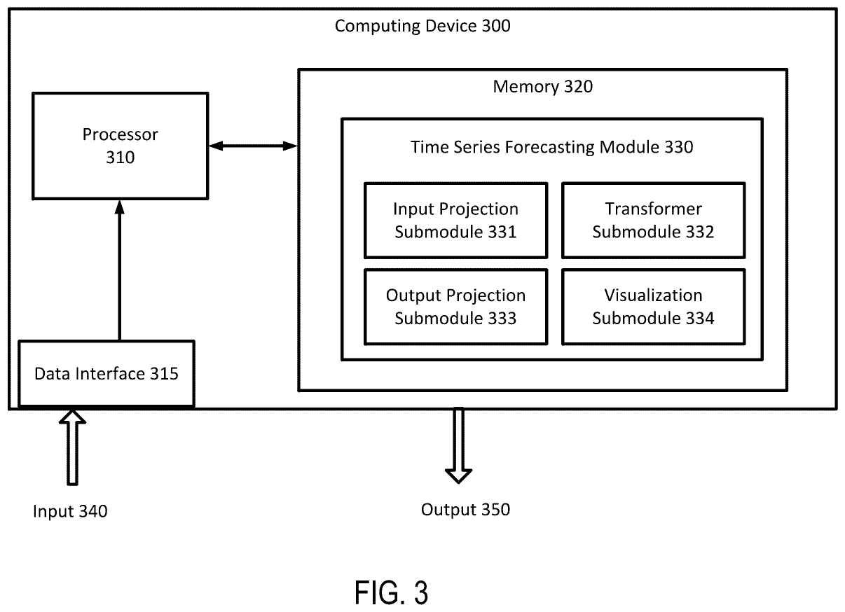

FIG. 3 is a simplified diagram illustrating a computing device implementing the time series forecasting framework described in FIGS. 1-2, according to one embodiment described herein. As shown in FIG. 3, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In another embodiment, processor 310 may comprise multiple microprocessors and/or memory 320 may comprise multiple registers and/or other memory elements such that processor 310 and/or memory 320 may be arranged in the form of a hardware-based neural network, as further described in FIG. 3.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for time series forecasting module 330 that may be used to implement and/or emulate the systems and models, and/or to implement any of the methods described further herein. Time series forecasting module 330 may receive input 340 such as an input time series via the data interface 315 and generate an output 350 which may be a forecasted time series.

The data interface 315 may comprise a communication interface, a user interface (such as a voice input interface, a graphical user interface, and/or the like). For example, the computing device 300 may receive the input 340 (such as a training time series data sample) from a networked database via a communication interface. Or the computing device 300 may receive the input 340, such as a testing time series data sample, from a user via the user interface.

In some embodiments, the time series forecasting module 330 is configured to forecasted time series data. The time series forecasting module 330 may further include a Transformer structure that comprises submodules such as an input projection submodule 331 (e.g., similar to the input projection layer in FIG. 2), a Transformer submodule 332 (e.g., similar to the Transformer layer in FIG. 2), an output projection submodule 333 (e.g., similar to the output projection layer in FIG. 2) and a visualization submodule 334.

For example, input projection submodule 331 may receive time series data via data interface 315, and generate patch embeddings from the input time serious data. The Transformer submodule 332 may further comprise a self-attention layer, a gating function and a mixture-of-expert (MoE) layer to generate attention weights of the patched embeddings. The output projection submodule 333 may then generate predicted probability distribution parameters. The visualization submodule 334 may generate visualized time series predictions via a graphical user interface.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

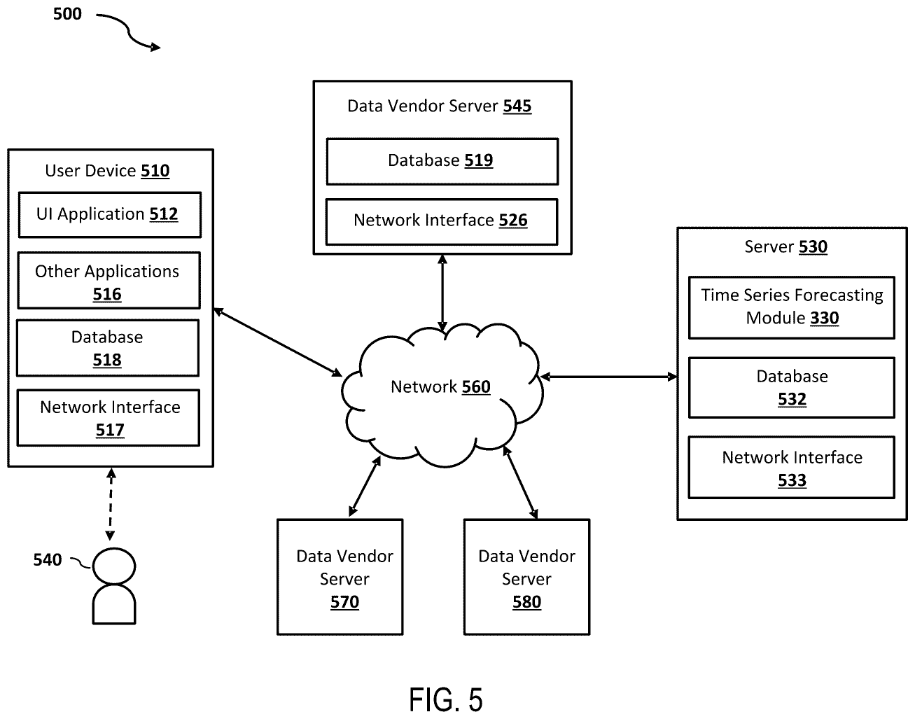

FIG. 4 is a simplified diagram illustrating the neural network structure implementing the time series forecasting module 330 described in FIG. 3, according to some embodiments. In some embodiments, the time series forecasting module 330 and/or one or more of its submodules 431-435 may be implemented at least partially via an artificial neural network structure shown in FIG. 5. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as an input image and an input text. The number of nodes (neurons) in the input layer 441 may be determined by the dimensionality of the input data (e.g., the length of a vector of a latent feature of the input image). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4, the time series forecasting module 330 receives an input 440 of an input image and transforms the input into an output 450 of an image representation. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the time series forecasting module 330 and/or one or more of its submodules 431-335 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a Transformer model, and/or the like.

In one embodiment, the time series forecasting module 330 and its submodules 331-334 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The [symbol] K, V matrices contain tunable weights of a Transformer-based language model that are updated during training. Then, the attention mechanism computes attention scores between all tokens in the input sequence using the [symbol] , K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the time series forecasting module 330 and its submodules 331-335 may be implemented by hardware, software and/or a combination thereof. For example, the time series forecasting module 330 and its submodules 331-334 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the time series forecasting module 330 and its submodules 331-334 and/or any other neural network models described in FIGS. 2A and 2B onto hardware platform 460, the neural network based modules 330 and its submodules 331-334 may be optimized for deployment by converting it to a suitable format, such as ONNX or TensorRT, to improve performance and compatibility. Next, depending on the size and workload requirements for modules 330 and its submodules 331-334, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the time series forecasting module 330 and its submodules 331-334 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the time series forecasting module 330 and its submodules 331-334 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the time series forecasting module 330 and its submodules 331-334 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the time series forecasting module 330 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based time series forecasting module 330 and one or more of its submodules 331-334 may be trained by iteratively updating the underlying parameters (e.g., weights 451, 452, etc., bias parameters and/or coefficients in the activation functions 461, 462 associated with neurons) of the neural network based on the loss. For example, during forward propagation, the training data such as a training image or a training text are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth”) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

Parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as different types of time series data, e.g., disease infection count, traffic management, and/or the like.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

Therefore, the training process transforms the neural network into an “updated” trained neural network with updated parameters such as weights, activation functions, and biases. The trained neural network thus improves neural network technology in applications of time series data.

FIG. 5 is a simplified block diagram of a networked system 500 suitable for implementing the time series forecasting framework described in FIGS. 1-4 and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive generated time series data.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating forecasted time series data from the server 530 and display the message via the UI application 512. In other embodiments, user device 510 may include additional or different modules having specialized hardware and/or software as required.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a forecast result from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view the visualized time series data.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including training images/texts to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the time series forecasting module 330 and its submodules described in FIG. 4. In some implementations, time series forecasting module 330 may receive data from database 519 at the data vendor server 545 via the network 560 to generate time series data forecasting. The generated forecast time series data may also be sent to the user device 510 for review by the user 540 via the network 560.

The database 532 may be stored in a transitory and/or non-transitory memory of the server 530. In one implementation, the database 532 may store data obtained from the data vendor server 545. In one implementation, the database 532 may store parameters of the time series forecasting module 330. In one implementation, the database 532 may store previously generated time series data, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Workflows

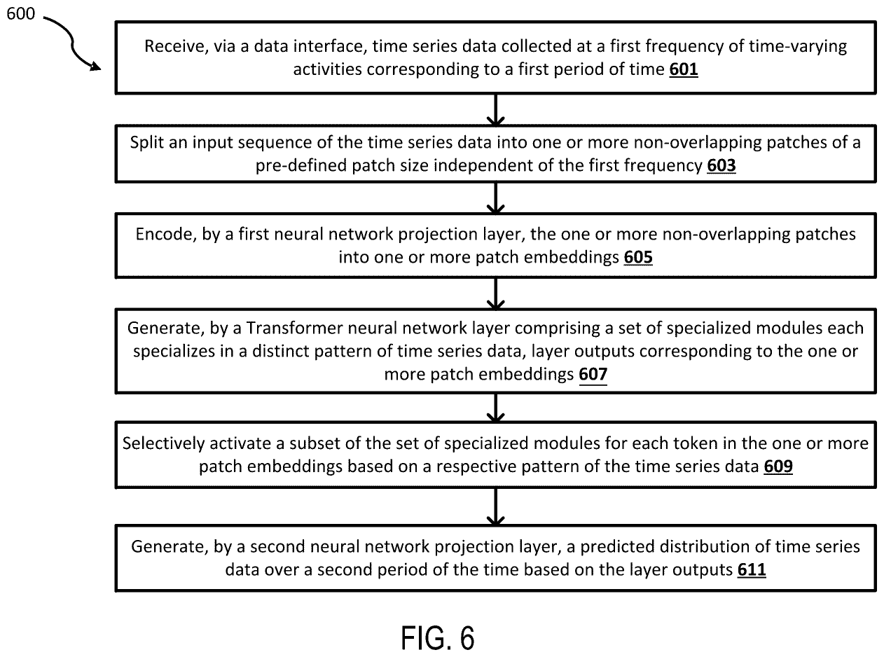

FIG. 6 is a simplified logic flow diagram illustrating aspects of a method of forecasting time series data for a future time period based on the Transformer based time series model illustrated in FIGS. 1-5, according to embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 600 corresponds to the operation of the time series forecasting module 330 (e.g., FIGS. 3 and 5).

As illustrated, the method 600 includes a number of enumerated steps, but aspects of the method 600 may include additional steps before, after, and in between the enumerated steps. In some aspects, one or more of the enumerated steps may be omitted or performed in a different order.

At step 601, a data interface (e.g., 315 in FIG. 3, network interface 533 in FIG. 5) may receive time series data collected at a first frequency of time-varying activities corresponding to a first period of time.

At step 603, an input sequence of the time series data (e.g., 119a-119c in FIG. 2A) may split into one or more non-overlapping patches (e.g., 201a-c in FIG. 2A) of a pre-defined patch size independent of the first frequency. For example, the time-series data may be multi-variate, e.g., the input sequence comprises a first subsequence corresponding to values of a first variate over the first period of time and a second subsequence concatenated to the first subsequence, corresponding to values of a second variate over the first period of time.

At step 605, a first neural network projection layer (e.g., 205 in FIG. 2A) may encode the one or more non-overlapping patches into one or more patch embeddings (e.g., 206 in FIG. 2A). For example, the first neural network projection layer encodes times series patches from time series data of different frequencies, wherein the time series data of different frequencies are split into time series patches of a same pre-defined patch size.

At step 607, a Transformer neural network layer (e.g., 210n in FIG. 2B) comprising a set of specialized modules (e.g., 228a-228c in FIG. 2B), each specializing in a distinct patten of time series data, layer outputs corresponding to the one or more patch embeddings. For example, the Transformer neural network layer comprises a self-attention module (e.g., 221 in FIG. 2B) that generate attention outputs indicating correlations between tokens of the one or more patch embeddings. For another example, the Transformer neural network layer comprises a gating module (e.g., 222 in FIG. 2B) that at least one affinity score between at least one of the set of specialized modules and a token from the one or more patch embeddings from the attention outputs. The at least one affinity score is computed as a Softmax operation over a top-K logits of a linear projection applied on the attention outputs. Or alternatively, the at least one affinity score is computed as a Softmax operation over a top-K Euclidean distances between the attention outputs and cluster centroids corresponding to the set of specialized modules. The cluster centroids are computed by performing k-means clustering on the attention outputs using a batch of training time series data, as described in relation to FIG. 2B.

At step 609, a subset of the set of specialized modules (e.g., 228a-c in FIG. 2B) may be selectively activated for each token in the one or more patch embeddings based on a respective pattern of the time series data. For example, as shown in FIG. 2B, E1 228a may be assigned embedding “1”, E2 220b may be assigned to embedding “2” and on. In one implementation, at least one specialized module is a feed forward layer, or a linear layer.

At step 611, a second neural network projection layer (e.g., 212 in FIG. 2A) may generate a predicted distribution (e.g., 213 in FIG. 2A) of time series data over a second period of the time based on the layer outputs. A predicted time series for the second period of time may thus be sampled according to the predicted distribution. The predicted time series may thus be caused to display at a user interface.

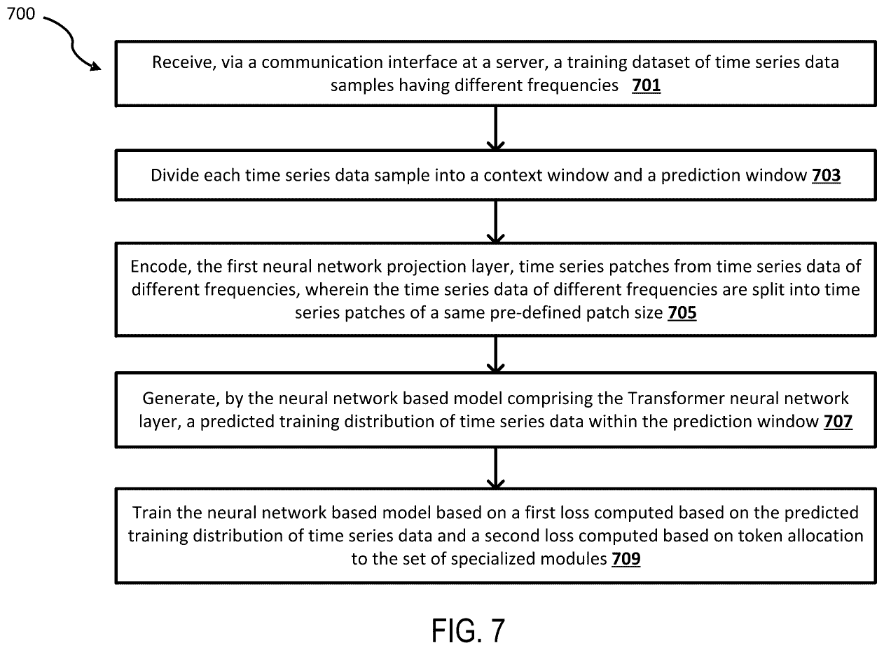

FIG. 7 is a simplified logic flow diagram illustrating aspects of a method of training a Transformer model for forecasting time series data for a future time period illustrated in FIGS. 1-5, according to embodiments described herein. One or more of the processes of method 700 may be implemented, at least in part, in the form of executable code stored on non-transitory, tangible, machine-readable media that when run by one or more processors may cause the one or mor7 processors to perform one or more of the processes. In some embodiments, method 600 corresponds to the operation of the time series forecasting module 330 (e.g., FIGS. 3 and 5).

As illustrated, the method 700 includes a number of enumerated steps, but aspects of the method 700 may include additional steps before, after, and in between the enumerated steps. In some aspects, one or more of the enumerated steps may be omitted or performed in a different order.

At step 701, a training dataset of time series data samples having different frequencies may be received.

At step 703, each time series data sample may be divided into a context window and a prediction window.

At step 705, the first neural network projection layer may encode the time series data samples having different frequencies. For example, the time-series data may be multi-variate, e.g., the input sequence comprises a first subsequence corresponding to values of a first variate over the first period of time and a second subsequence concatenated to the first subsequence, corresponding to values of a second variate over the first period of time.

At step 707, the neural network based model (e.g., 210 in FIG. 2A) comprising the Transformer neural network layer (e.g., 210n in FIG. 2B) may generate a predicted training distribution of time series data within the prediction window.

At step 709, the neural network based model may then be trained based on a first loss (e.g., a prediction loss shown in Eq. (1)) computed based on the predicted training distribution of time series data and a second loss (e.g., a load balancing loss shown in Eq. (2)) computed based on token allocation to the set of specialized modules.

In some embodiments, methods 600-700 are applicable in a variety of applications. For example, time series forecasting may be used in different domains. Methods 600-700 may be used in weather forecasting to predict temperature, precipitation, and other meteorological conditions. Healthcare may use methods 600-700 time series prediction for monitoring patient vital signs and anticipating disease outbreaks. In energy, method 600-700 may aid in forecasting electricity demand, optimizing power grid operations, and predicting renewable energy generation. In this way, predicted times series data, such as weather data, healthcare data, energy consumption data, and/or the like, may be used in decision-making to carry out certain actions, such as generating weather alerts, adjusting power grids, making medical preventative and/or diagnostic treatment plans, and/or the like.

### Example Data Experiments

Example data experiments are performed using the number of activated experts as K=2 for the Time series forecasting module 330 (referred to as “MOIRAI-MoE”), resulting in 11M/86M activated parameters per token for MOIRAI-MoE_{S}/MOIRAI-MoE_{B}, closely matching the dense model MOIRAI_{S}/MOIRAI_{B} that contains 14M/91M activated parameters. The total number of experts M is set to 32, yielding total parameter sizes of 117M for MOIRAI-MoE_{S} and 935M for MOIRAI-MoE_{B}. MOIRAI-MoE_{L} is not presented due to the significant requirements of computational resources. The specific configurations are outlined in Table 1.

TABLE 1
Model configurations of MOIRAI and MOIRAI-MOE.

| | | | | Activated | Total | Activated | Total |
|---|---|---|---|---|---|---|---|
| Model | Layers | dmodel | dff | Params | Params | Experts | Experts |
| MOIRAI_{S} | 6 | 384 | 1,024 | 14M | 14M | — | — |
| MOIRAI_{B} | 12 | 768 | 2,048 | 91M | 91M | — | — |
| MOIRAI_{L} | 24 | 1,024 | 2,736 | 310M | 310M | — | — |
| MOIRAI-MOE_{S} | 6 | 384 | 512 | 11M | 117M | 2 | 32 |
| MOIRAI-MOE_{B} | 12 | 768 | 1,024 | 86M | 935M | 2 | 32 |

In one embodiment, in-distribution forecasting experiments are performed. An in-distribution evaluation using a total of 29 datasets from the Monash benchmark (described in Godahewa et al., Monash time series forecasting archive. arXiv preprint arXiv: 2105.06643, 2021). The training set are included in LOTSA (Woo et al., Unified training of universal time series forecasting transformers, in proceedings of International Conference on Machine Learning, 2024), holding out the test set which we now use for assessments. FIG. 8 summarizes the results based on the aggregated mean absolute error (MAE), in comparison with the baselines presented in the Monash benchmark and additional foundation models:

TIDE (Das et al., Long-term forecasting with tide: Time-series dense encoder, Transactions on Machine Learning Research, 2023) which encodes the historical data of a time series along with covariates using dense multi-layer perceptrons (MLPs). It then decodes the time series while incorporating future covariates, also utilizing dense MLPs for this process.

PatchTST (Nie et al., A time series is worth 64 words: Long-term forecasting with transformers. In International Conference on Learning Representations, 2023) which employs Transformer encoders combined with patching and channel independence techniques to enhance the performance of time series forecasting. iTransformer (Liu et al., iTransformer: Inverted transformers are effective for time series forecasting, in Proceedings of International Conference on Learning Representations, 2024b) treats independent time series as tokens to effectively capture multivariate correlations through self-attention.

MoLE-DLinear (Ni et al., Mixture-of-linear-experts for long-term time series forecasting, in International Conference on Artificial Intelligence and Statistics, pp. 4672-4680, 2024) which trains multiple linear-centric models (i.e., experts) and a router model that weighs and mixes their outputs.

LLMTime (Gruver et al., Large language models are zero-shot time series forecasters, in Advances in Neural Information Processing Systems, 2023) is a method for time series forecasting that leverages Large Language Models by encoding numerical data as text and generating possible future values through text completions.

TimesFM (Das et al., A decoder-only foundation model for time-series forecasting. In International Conference on Machine Learning, 2024) is a decoder-only time series foundation model that pretrained on a large corpus of time series data, including both real-world and synthetic datasets.

TTM (Ekambaram et al., TTMS: Fast multi-level tiny time mixers for improved zero-shot and few-shot forecasting of multivariate time series. arXiv preprint arXiv: 2401.03955, 2024) is a foundation model based on the light-weight TSMixer architecture, incorporating innovations like adaptive patching, diverse resolution sampling, and resolution prefix tuning.

Timer (Liu et al., Timer: Generative pre-trained transformers are large time series models. In Forty-first International Conference on Machine Learning, 2024) is a decoder-only foundation model, presenting notable few-shot generalization, scalability, and task generality.

Moment (Goswami et al., Moment: A family of open time-series foundation models. arXiv preprint arXiv:2402.03885, 2024) refers to a family of open time series foundation models that can handle different time series analysis tasks.

Chronos (Ansari et al., Chronos: Learning the language of time series. arXiv preprint arXiv:2403.07815, 2024) is an encoder-decoder time series foundation model that uses quantization to convert real numbers into discrete tokens.

MOIRAI (Woo et al., Unified training of universal time series forecasting transformers, in proceedings of International Conference on Machine Learning, 2024) is a time series foundation model trained on the LOTSA dataset, which contains over 27 billion observations across nine diverse domains.

Time-MoE (Shi et al., TimeMoE: Billion-scale time series foundation models with mixture of experts. arXiv preprint arXiv:2409.16040, 2024) is a concurrent work that applies mixture of experts techniques to time series foundation models.

Example evaluation results show that the proposed Transformer model described herein, “MOIRAI-MoE” outperforms all of the above. In particular, MOIRAI-MoE_{S} outperforms the larger models MOIRAI_{B} and MOIRAI_{L} by 8% and 7%, respectively. MOIRAI-MoE_{B} delivers a further 3% improvement over MOIRAI-MoE_{S}. Compared to the foundation model Chronos, which MOIRAI could not surpass, MOIRAI-MoE successfully bridges the gap and delivers superior results with up to 65× fewer activated parameters.

Table 2 shows an out-of-distribution evaluation is conducted on 10 datasets not included in LOTSA. To establish a comprehensive comparison, we report results for both probabilistic and point forecasting, using continuous ranked probability score (CRPS) and mean absolute scaled error (MASE) as evaluation metrics. MOIRAI-MoE_{B} achieves the best overall zero-shot performance, outperforming TimesFM and Chronos that included partial evaluation data in their pretraining corpora. When compared to all sizes of MOIRAI, MOIRAI-MoE_{S} delivers a 3%-14% improvement in CRPS and an 8%-16% improvement in MASE. These improvements are remarkable, considering that MOIRAI-MoE_{S} has only 11M activated parameters−28× fewer than MOIRAI_{L}.

TABLE 2
Zero-shot performance of probabilistic and point forecasting.

| | | | | | | | | | | | | | Avg |
|---|---|---|---|---|---|---|---|---|---|---|---|---|---|
| | | | | | | | | | | | | Avg | (non- |
| Method | Metric | Electricity | Solar | Power | ETT1 | ETT2 | Traffic | MDENSE | Walmart | Weather | BizITObs | (all) | leak) |
| Seasonal | CRPS | 0.070 | 0.512 | 0.085 | 0.515 | 0.205 | 0.257 | 0.294 | 0.151 | 0.068 | 0.262 | 1.000 | 1.000 |
| Naive | MASE | 0.881 | 1.203 | 0.906 | 1.778 | 1.390 | 1.137 | 1.669 | 1.236 | 0.782 | 0.986 | 1.000 | 1.000 |
| [symbol] | CRPS | 0.048 | 0.420 | 0.046 | 1.056 | 0.130 | 0.110 | 0.091 | 0.077 | 0.054 | 0.124 | 0.631 | 0.604 |
| | MASE | 0.706 | 1.265 | 0.904 | 6.898 | 2.189 | 0.618 | 0.911 | 0.814 | 0.832 | 0.450 | 0.931 | 0.934 |
| PatchTST | CRPS | 0.052 | 0.518 | 0.054 | 0.304 | 0.131 | 0.112 | 0.070 | 0.082 | 0.059 | 0.074 | 0.549 | 0.490 |
| | MASE | 0.753 | 1.607 | 1.234 | 1.680 | 2.168 | 0.653 | 0.732 | 0.867 | 0.844 | 0.266 | 0.808 | 0.753 |
| iTransformer | CRPS | 0.057 | 0.443 | 0.056 | 0.344 | 0.129 | 0.105 | 0.072 | 0.070 | 0.053 | 0.077 | 0.540 | 0.483 |
| | MASE | 0.875 | 1.342 | 1.076 | 2.393 | 1.841 | 0.581 | 0.727 | 0.761 | 0.623 | 0.271 | 0.767 | 0.708 |
| MoLE- | CRPS | 0.083 | 0.535 | 0.072 | 0.344 | 0.188 | 0.237 | 0.108 | 0.137 | 0.079 | 0.095 | 0.780 | 0.714 |
| DLinear | MASE | 0.984 | 1.257 | 1.325 | 1.606 | 3.194 | 1.016 | 0.914 | 1.115 | 0.925 | 0.282 | 0.938 | 0.906 |
| TimesFM | CRPS | 0.045* | 0.456 | 0.037 | 0.280 | 0.113 | 0.131 | 0.070 | 0.067 | 0.042 | 0.080 | 0.488 | 0.439 |
| | MASE | 0.655* | 1.391 | 0.851 | 1.700 | 1.644 | 0.678 | 0.702 | 0.735 | 0.440 | 0.310 | 0.689 | 0.640 |
| [symbol] | CRPS | 0.075 | 0.534* | 0.059 | 0.417 | 0.122 | 0.210 | 0.150 | 0.192 | 0.055 | 0.102 | 0.758 | 0.697 |
| | MASE | 0.802 | 1.255* | 0.898 | 1.934 | 1.547 | 0.901 | 1.195 | 1.477 | 0.506 | 0.308 | 0.831 | 0.798 |
| Timer | CRPS | 0.084 | 0.573 | 0.066 | 0.345 | 0.135 | 0.182 | 0.152 | 0.151 | 0.092 | 0.120 | 0.797 | 0.726 |
| | MASE | 0.967 | 1.344 | 1.006 | 1.697 | 1.754 | 0.770 | 1.196 | 1.219 | 0.655 | 0.376 | 0.871 | 0.820 |
| Moment | CRPS | 0.354 | 1.332 | 0.151 | 0.401 | 0.277 | 0.612 | 0.157 | 0.154 | 0.105 | 0.313 | 1.502 | 1.205 |
| | MASE | 3.167 | 3.139 | 2.244 | 2.243 | 4.100 | 2.617 | 1.277 | 1.245 | 1.053 | 0.913 | 1.691 | 1.457 |
| Chronos_{S} | CRPS | 0.043* | 0.389* | 0.038 | 0.360 | 0.097 | 0.124 | 0.087 | 0.079 | 0.089 | 0.087 | 0.543 | 0.513 |
| | MASE | 0.629* | 1.193* | 0.717 | 1.799 | 1.431 | 0.622 | 0.834 | 0.849 | 0.606 | 0.301 | 0.694 | 0.661 |
| Chronos_{B} | CRPS | 0.041* | 0.341* | 0.039 | 0.387 | 0.092 | 0.109 | 0.075 | 0.080 | 0.058 | 0.084 | 0.499 | 0.471 |
| | MASE | 0.617* | 1.002* | 0.722 | 1.898 | 1.265 | 0.553 | 0.712 | 0.849 | 0.583 | 0.301 | 0.656 | 0.631 |
| Chronos_{L} | CRPS | 0.041* | 0.339* | 0.038 | 0.404 | 0.091 | 0.117 | 0.075 | 0.073 | 0.062 | 0.084 | 0.500 | 0.473 |
| | MASE | 0.615* | 0.987* | 0.702 | 1.959 | 1.270 | 0.597 | 0.724 | 0.788 | 0.601 | 0.310 | 0.660 | 0.638 |
| MOIRAIS | CRPS | 0.072 | 0.471 | 0.048 | 0.275 | 0.101 | 0.173 | 0.084 | 0.103 | 0.049 | 0.081 | 0.578 | 0.507 |
| | MASE | 0.981 | 1.465 | 0.948 | 1.701 | 1.417 | 0.990 | 0.836 | 1.048 | 0.521 | 0.301 | 0.798 | 0.726 |
| MOIRAIB | CRPS | 0.055 | 0.419 | 0.040 | 0.301 | 0.095 | 0.116 | 0.104 | 0.093 | 0.041 | 0.078 | 0.520 | 0.467 |
| | MASE | 0.792 | 1.292 | 0.888 | 1.736 | 1.314 | 0.644 | 1.101 | 0.964 | 0.487 | 0.291 | 0.736 | 0.685 |
| MOIRAIL | CRPS | 0.050 | 0.406 | 0.036 | 0.286 | 0.094 | 0.112 | 0.095 | 0.098 | 0.051 | 0.079 | 0.514 | 0.467 |
| | MASE | 0.751 | 1.237 | 0.870 | 1.750 | 1.436 | 0.631 | 0.957 | 1.007 | 0.515 | 0.285 | 0.729 | 0.685 |
| Time- | CRPS | 0.051* | 0.230* | 0.044 | 0.392 | 0.125 | 0.152 | 0.099 | 0.100 | 0.070 | 0.112 | 0.583 | 0.586 |
| MoE_{B} | MASE | 0.587* | 0.535* | 0.800 | 1.823 | 1.672 | 0.672 | 0.846 | 0.833 | 0.558 | 0.343 | 0.662 | 0.695 |
| Time- | CRPS | 0.051* | 0.294* | 0.045 | 0.386 | 0.131 | 0.172 | 0.090 | 0.097 | 0.058 | 0.111 | 0.589 | 0.576 |
| MoE_{L} | MASE | 0.581* | 0.689* | 0.790 | 1.773 | 1.878 | 0.762 | 0.759 | 0.817 | 0.524 | 0.337 | 0.678 | 0.695 |
| MOIRAI- | CRPS | 0.046 | 0.429 | 0.036 | 0.288 | 0.093 | 0.108 | 0.071 | 0.090 | 0.056 | 0.081 | 0.497 | 0.450 |
| MOES | MASE | 0.719 | 1.222 | 0.737 | 1.750 | 1.248 | 0.563 | 0.746 | 0.927 | 0.476 | 0.298 | 0.670 | 0.620 |
| MOIRAI- | CRPS | 0.041 | 0.382 | 0.034 | 0.296 | 0.091 | 0.100 | 0.071 | 0.088 | 0.057 | 0.079 | 0.478 | 0.439 |
| MOEB | MASE | 0.638 | 1.161 | 0.725 | 1.748 | 1.247 | 0.510 | 0.721 | 0.918 | 0.509 | 0.290 | 0.651 | 0.611 |

Asterisks (*) indicate the non-zero-shot datasets. The Avg column is normalized by seasonal naive, followed by geometric mean. Two Avg values are shown: one that averages all data, and another (non-leak) excludes Electricity and Solar. Best average results are highlighted in bold, and second best results are in underline. Power: Turkey Power. Traffic: Istanbul Traffic. Weather: Jena Weather. BizITObs: BizITObs-L2C. [symbol]
indicates data missing or illegible when filed

As shown above, the experiment results showcase MOIRAI-MoE's overall model design, demonstrates the strong generalization ability of MOIRAI-MoE, and emphasizes the superiority of token-level specialization over frequency-level approaches (TimesFM, MOIRAI) and models without a specialization module (Chronos). MOIRAI-MoE also performs significantly better than full-shot models trained on each dataset, showing the exceptional capabilities of foundation models.

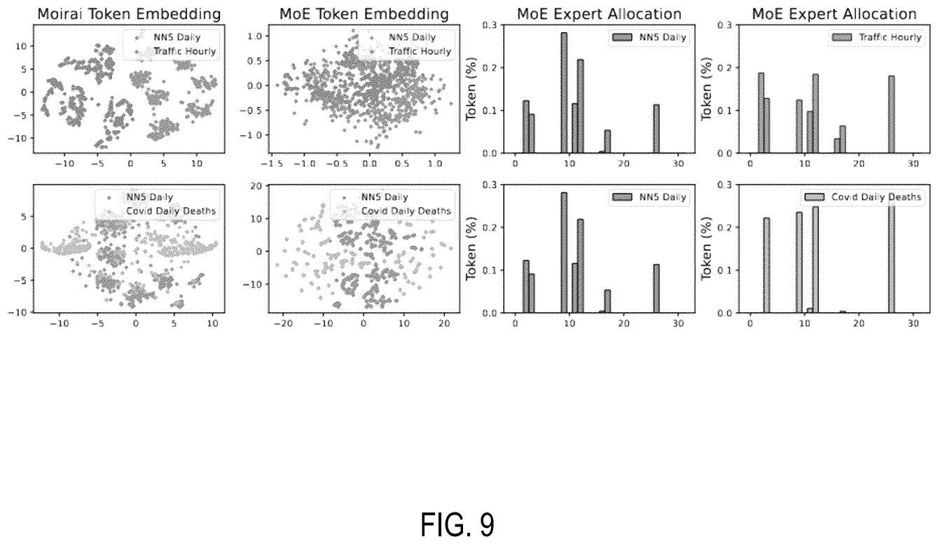

FIG. 9 illustrates example experiment results of token embedding distribution of MOIRAI-MoE, effectively improving forecasting performance. In FIG. 9, token embeddings generated from the input projection layers of MOIRAI and MOIRAI-MoE are compared. In the first row, the NN5 Daily and Traffic Hourly datasets, which have different frequencies but exhibit similar underlying patterns. FIG. 9 illustrates that MOIRAI produces distinct embeddings due to the use of separate frequency projection layers, while MOIRAI-MoE successfully blends their representations together. Their inherent similarities are further demonstrated by their comparable expert allocation distributions in the last two columns. In the second row of FIG. 9, another daily frequency dataset, Covid Daily Deaths, which shows distinct patterns compared to NN5 Daily. The embeddings of these two datasets overlap to some extent in the MOIRAI model but are effectively separated in MOIRAI-MoE. Furthermore, the Covid Daily dataset shows different expert selection choices than NN5 Daily due to different token embeddings. The data-driven modeling paradigm of MOIRAI-MoE ultimately leads to significant performance boosts, reducing the MAE of NN5 Daily from 5.37 to 4.04 (a 25% improvement), the MAE of Traffic Hourly from 0.02 to 0.013 (a 35% improvement), and the MAE of Covid Daily Deaths from 124.32 to 119 (a 4% improvement).

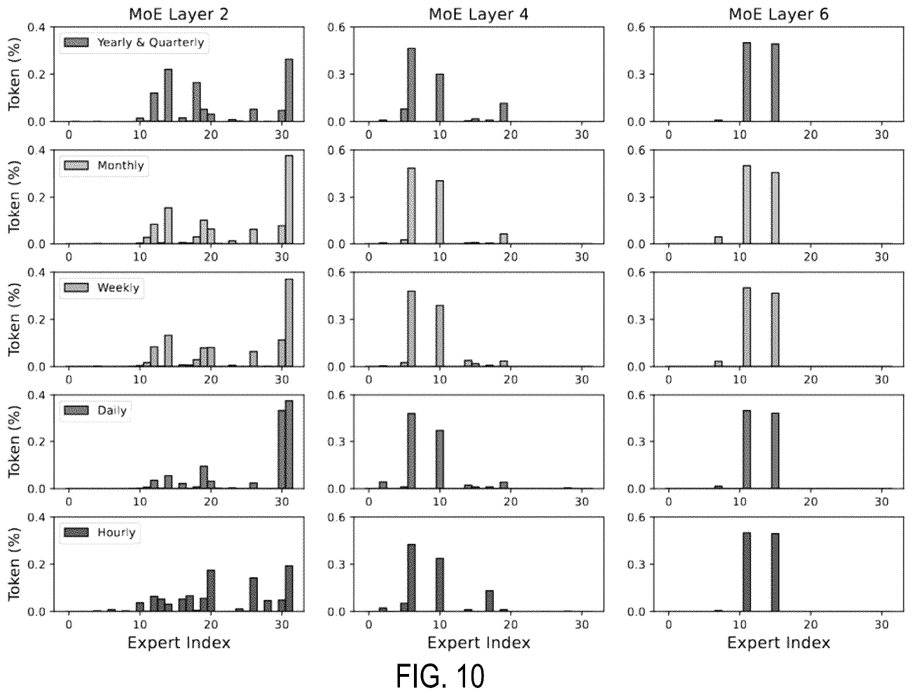

FIG. 10 shows different frequency data exhibit different expert selection distributions at shallow layers but similar distributions at deep layers. In the shallow layers, expert selection is notably diverse, indicating that the model relies on multiple experts to manage the high level of short-term variability, such as cyclical, seasonal, or abrupt changes. As tokens are aggregated in deeper layers, the model shifts its focus to more generalizable temporal dependencies, such as broader trends and long-term patterns, that can be shared across different frequencies and leads to more concentrated experts being selected. By the final layer (layer 6), expert allocation becomes nearly identical across all frequencies, suggesting that the model has abstracted time series into high-level representations largely independent of the frequency. This evidence indicates that MOIRAI-MoE effectively achieves frequency-invariant hidden representations. The shared parameter space in the last layer also shows that it is sufficient for generating representations needed to make diverse predictions.

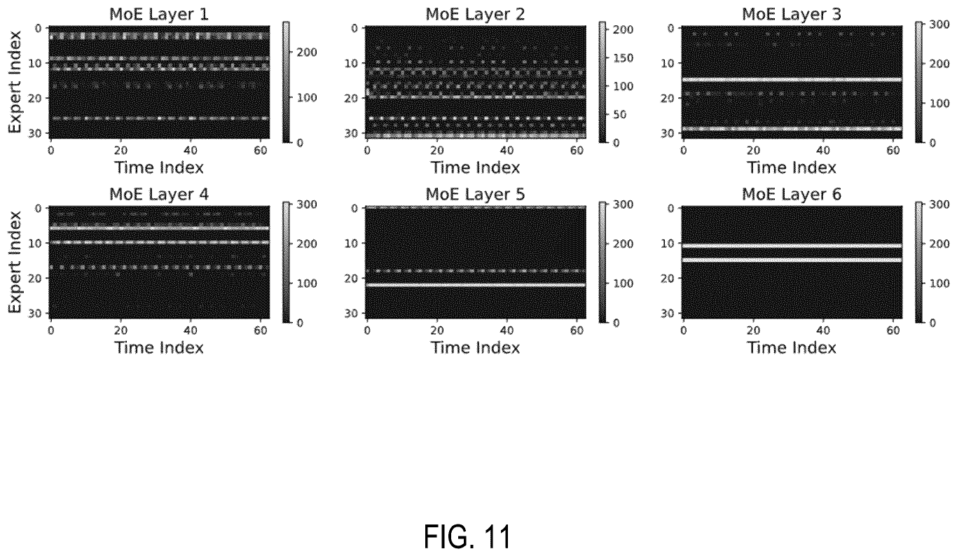

FIG. 11 shows expert allocation reflects time series periodicity patterns. To investigate the relationship between the positions of time series tokens and expert allocations, we use hourly data from the Monash repository with a minimum context length of 1,000 (e.g., the Traffic Hourly dataset). FIG. 11 visualizes the expert choices at each token position. In the shallow layers, we observe that expert selection follows periodic patterns, consistent with the actual patterns in the raw data. This suggests that the model dynamically adapts to the cyclical nature of the traffic data, assigning specialized experts to manage tokens corresponding to distinct phases of the cycle, such as rising, peaks, and falling. Therefore, Moirai-MoE effectively learns to exploit time-based structures and the model specialization operates at the token level.

In addition, due to the difference in the inference algorithms (the mask encoder in MOIRAI predicts all tokens simultaneously, while the decoder-only approach in MOIRAI-MoE generates predictions autoregressively), the inference cost on a subset of the Monash benchmark where the predicted token is one (corresponding to 16 time steps) to eliminate this discrepancy is evaluated. To also compare to the foundation model Chronos, the context length is set to 512 and the number of sampling samples to 20, aligning with the settings used in Chronos.

Table 3 showcases that MOIRAI-MoE_{S} and MOIRAI-MoE_{B} exhibit similar inference times to MOIRAI_{S} and MOIRAI_{B}, respectively. These results highlight that MOIRAI-MoE not only maintains the same level of efficiency as MOIRAI but also delivers substantial performance improvements. Additionally, when comparing MOIRAI-MoE to Chronos, which also employs autoregressive inference algorithms, we find that MOIRAI-MoE is significantly faster. This speed advantage stems from the fact that MOIRAI-MoE generates predictions using patches of size 16, while Chronos can be viewed as using a patch size of 1, which greatly affects its inference efficiency.

TABLE 3
Inference cost evaluation.

| | Model | | | | | | | |
|---|---|---|---|---|---|---|---|---|
| | | | | | | | MOIRAI- | MOIRAI- |
| | Chronos_{S} | Chronos_{B} | Chronos_{L} | MOIRAI_{S} | MOIRAI_{B} | MOIRAI_{L} | MoE_{S} | MoE_{B} |
| | (46M) | (200M) | (710M) | (14M) | (91M) | (310M) | (11M/117M) | (86M/935M) |
| Spent Time | 551 | 1,177 | 2,780 | 264 | 358 | 537 | 273 | 370 |

The values in brackets represent the parameter sizes of the foundation models. For MoE models, the two values indicate the number of activated parameters and the total number of parameters. The spent time is in seconds.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of forecasting time series data for a future time period by a neural network based model, the method comprising:
receiving, via a data interface, time series data collected at a first frequency of time-varying activities corresponding to a first period of time;
splitting an input sequence of the time series data into one or more non-overlapping patches of a pre-defined patch size independent of the first frequency;
encoding, by a first neural network projection layer, the one or more non-overlapping patches into one or more patch embeddings;
generating, by a Transformer neural network layer comprising a set of specialized modules each specializes in a distinct patter of time series data, layer outputs corresponding to the one or more patch embeddings,
wherein a subset of the set of specialized modules are selectively activated for each token in the one or more patch embeddings based on a respective pattern of the time series data; and
generating, by a second neural network projection layer, a predicted distribution of time series data over a second period of the time based on the layer outputs.

2. The method of claim 1, wherein the input sequence comprises a first subsequence corresponding to values of a first variate over the first period of time and a second subsequence concatenated to the first subsequence, corresponding to values of a second variate over the first period of time.

3. The method of claim 1, wherein the Transformer neural network layer comprises a self-attention module that generate attention outputs indicating correlations between tokens of the one or more patch embeddings.

4. The method of claim 3, wherein the Transformer neural network layer comprises a gating module that at least one affinity score between at least one of the set of specialized modules and a token from the one or more patch embeddings from the attention outputs.

5. The method of claim 4, wherein the at least one affinity score is computed as a Softmax operation over a top-K logits of a linear projection applied on the attention outputs.

6. The method of claim 4, wherein the at least one affinity score is computed as a Softmax operation over a top-K Euclidean distances between the attention outputs and cluster centroids corresponding to the set of specialized modules,
wherein the cluster centroids are computed by performing k-means clustering on the attention outputs using a batch of training time series data.

7. The method of claim 4, wherein the subset of the set of specialized modules are selectively activated for the each token based on the at least one affinity score, and
wherein at least one specialized module is a feed forward layer.

8. The method of claim 4, wherein the layer outputs are generated by:
multiplying the at least one affinity score with a module output from at least one selectively activated specialized module; and
aggregating multiplication results over the set of specialized modules.

9. The method of claim 1, wherein the first neural network projection layer encodes times series patches from time series data of different frequencies, wherein the time series data of different frequencies are split into time series patches of a same pre-defined patch size.

10. The method of claim 1, further comprising:
receiving a training dataset of time series data samples having different frequencies;
dividing each time series data sample into a context window and a prediction window;
encoding, by the first neural network projection layer, the time series data samples having different frequencies;
generating, by the neural network based model comprising the Transformer neural network layer, a predicted training distribution of time series data within the prediction window;
training the neural network based model based on a first loss computed based on the predicted training distribution of time series data and a second loss computed based on token allocation to the set of specialized modules.

11. A system of forecasting time series data for a future time period by a neural network based model, the system comprising:
a data interface receiving time series data collected at a first frequency of time-varying activities corresponding to a first period of time;
a memory storing a plurality of processor-executable instructions, the processor-executable instructions being executed by one or more processors to perform operations comprising:
splitting an input sequence of the time series data into one or more non-overlapping patches of a pre-defined patch size independent of the first frequency;
encoding, by a first neural network projection layer, the one or more non-overlapping patches into one or more patch embeddings;
generating, by a Transformer neural network layer comprising a set of specialized modules each specializes in a distinct patter of time series data, layer outputs corresponding to the one or more patch embeddings,
wherein a subset of the set of specialized modules are selectively activated for each token in the one or more patch embeddings based on a respective pattern of the time series data; and
generating, by a second neural network projection layer, a predicted distribution of time series data over a second period of the time based on the layer outputs.

12. The system of claim 11, wherein the input sequence comprises a first subsequence corresponding to values of a first variate over the first period of time and a second subsequence concatenated to the first subsequence, corresponding to values of a second variate over the first period of time.

13. The system of claim 11, wherein the Transformer neural network layer comprises a self-attention module that generate attention outputs indicating correlations between tokens of the one or more patch embeddings.

14. The system of claim 13, wherein the Transformer neural network layer comprises a gating module that at least one affinity score between at least one of the set of specialized modules and a token from the one or more patch embeddings from the attention outputs.

15. The system of claim 14, wherein the at least one affinity score is computed as one of:
a Softmax operation over a top-K logits of a linear projection applied on the attention outputs; or
a Softmax operation over a top-K Euclidean distances between the attention outputs and cluster centroids corresponding to the set of specialized modules,
wherein the cluster centroids are computed by performing k-means clustering on the attention outputs using a batch of training time series data.

16. The system of claim 14, wherein the subset of the set of specialized modules are selectively activated for the each token based on the at least one affinity score, and
wherein at least one specialized module is a feed forward layer.

17. The system of claim 14, wherein the layer outputs are generated by:
multiplying the at least one affinity score with a module output from at least one selectively activated specialized module; and
aggregating multiplication results over the set of specialized modules.

18. The system of claim 11, wherein the first neural network projection layer encodes times series patches from time series data of different frequencies, wherein the time series data of different frequencies are split into time series patches of a same pre-defined patch size.

19. The system of claim 11, wherein the operations further comprise:
receiving a training dataset of time series data samples having different frequencies;
dividing each time series data sample into a context window and a prediction window;
encoding, by the first neural network projection layer, the time series data samples having different frequencies;
generating, by the neural network based model comprising the Transformer neural network layer, a predicted training distribution of time series data within the prediction window;
training the neural network based model based on a first loss computed based on the predicted training distribution of time series data and a second loss computed based on token allocation to the set of specialized modules.

20. A non-transitory processor-readable medium storing a plurality of processor-executable instructions for forecasting time series data for a future time period by a neural network based model, the instructions being executed by one or more processors to perform operations comprising:
receiving, via a data interface, time series data collected at a first frequency of time-varying activities corresponding to a first period of time;
splitting an input sequence of the time series data into one or more non-overlapping patches of a pre-defined patch size independent of the first frequency;
encoding, by a first neural network projection layer, the one or more non-overlapping patches into one or more patch embeddings;
generating, by a Transformer neural network layer comprising a set of specialized modules each specializes in a distinct patter of time series data, layer outputs corresponding to the one or more patch embeddings,
wherein a subset of the set of specialized modules are selectively activated for each token in the one or more patch embeddings based on a respective pattern of the time series data; and
generating, by a second neural network projection layer, a predicted distribution of time series data over a second period of the time based on the layer outputs.
